(19) United States
(12) Patent Application Publication
(10) Pub. No.: US 2014/0217343 A1
(43) Pub. Date: Aug. 7, 2014

(54) LIFTING APPARATUS FOR AN AIRCRAFT

(71) Applicant: Thomas Sefrin, Obersimten (DE)

(72) Inventor: Thomas Sefrin, Obersimten (DE)

(21) Appl. No.: 14/240,764

(22) PCT Filed: Aug. 23, 2012
(86) PCT No.: PCT/DE2012/000859

§ 371 Date: Mar. 24, 2014

(30) Foreign Application Priority Data
Aug. 29, 2011 (DE) 10 2011 118 758.1

(51) Int. Cl. B66F 3/35

(52) U.S. Cl. CPC B66F 3/35
USPC 254/93 HP

(57) ABSTRACT

The invention relates to a lifting apparatus (16) for an aircraft (1), comprising: at least one cushion (19) which can be blown up and has at least two chambers (20, 21); at least one compressor; and at least one pressure control device, wherein each of the chambers is connected to the compressor (7) via the pressure control device by means of a hose (9), wherein the lifting apparatus comprises a pressure-sensitive device (23) having at least two pressure sensors (25), and the pressure-sensitive device is arranged between the uppermost chamber of the cushion and that region of the aircraft to be lifted.

The present invention relates to a lifting apparatus for an aircraft, comprising at least one inflatable cushion with at least two chambers, at least one compressor and at least one pressure control device, wherein each of the chambers is connected to the compressor via the pressure control device by means of a hose.

Lifting aircraft by means of lifting apparatuses is known in the prior art. The lifting of an aircraft with a lifting apparatus is necessary, in particular, when the aircraft has to be serviced or if an undesired operating state of the aircraft, that is to say an accident, occurs. An undesired operating state occurs, for example, when an aircraft is in a tilted state owing to incorrect loading and has to be returned to a satisfactory position. It may also be the case that landing gear is not deployed or is damaged during landing, with the result that the aircraft rests with its tail or wings on the ground, at least in certain areas.

In the prior art, various configurations of landing gear damage are known which require the aircraft to be lifted at respective different areas of the aircraft. This may be case, for example, when the front landing gear of an aircraft has collapsed and therefore the front area of the aircraft is resting on the ground or on a runway. Other frequently occurring configurations are loss or collapse of one or more main sets of landing gear, also together with the front landing gear or landing on an uneven underlying surface beyond a landing runway which is provided.

Irrespective of the cause of the undesired operating state of the aircraft, rapid recovery of such aircraft is decisive owing to the high costs of a blocked runway or a blocked area of an airport. Variable aircraft lifting apparatuses which can be used in a versatile fashion are required for recovering aircrafts since the different types of accident which are described can occur with a wide variety of aircraft types.

In the prior art it is known, for example, to lift aircraft by means of what are referred to as “recovery jacks”—special hydraulic lifting apparatuses which have to be attached to predetermined points of an aircraft in order to be able to lift it (DE 10 2006 007 504 A1).

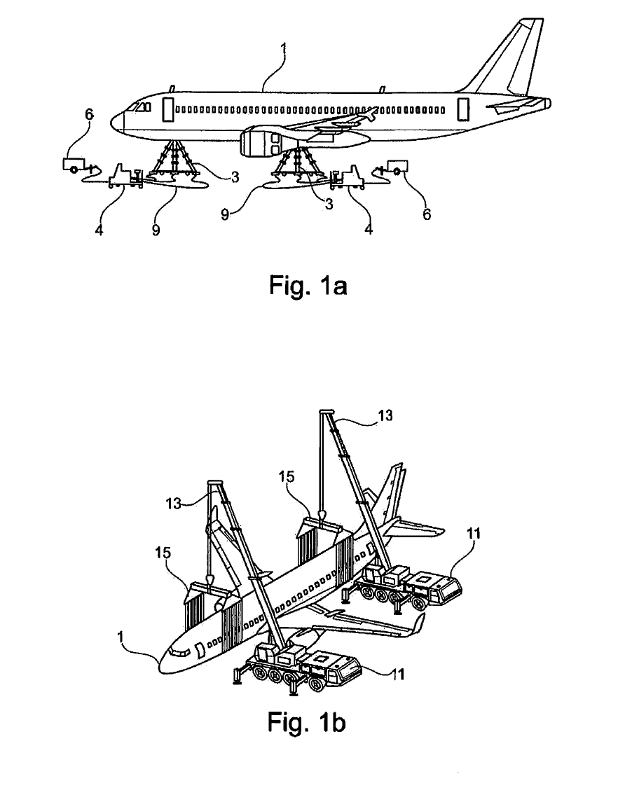

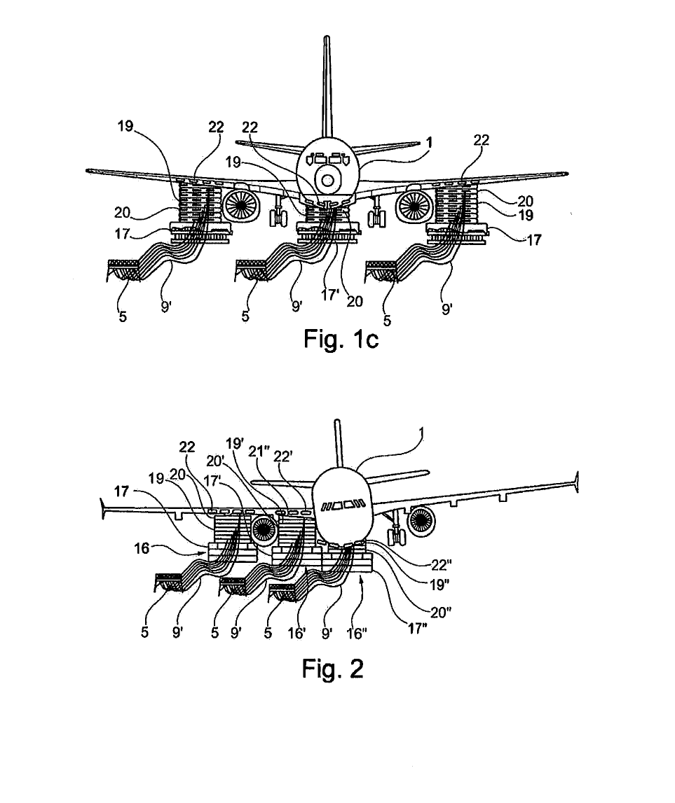

An example of lifting an aircraft with said recovery jacks is shown in FIG. 1a relating to the prior art. A plurality of recovery jacks 3, which act at special, predetermined points (not shown) of the aircraft 1, are arranged underneath an aircraft 1. In order to lift the aircraft 1 in a controlled fashion, hydraulic assemblies 4 with a hydraulic pump and with an integrated control device are provided. The lifting is regulated by means of the hydraulic assemblies 4 and the integrated control devices thereof, wherein a power supply of the hydraulic pumps is made available by a generator 6. In this context, the recovery jacks 3 are connected to the hydraulic assemblies 4 by means of hoses 9.

A disadvantage of the known recovery jacks is that they have to be kept available individually for an aircraft type. They are usually available only at specific airports and often have to be flown into the location of the aircraft involved in an accident. Lifting with recovery jacks is therefore often time-consuming and expensive.

With respect to the lifting of aircraft, the prior art (U.S. Pat. No. 3,160,288 A) also discloses cranes, see FIG. 1b relating to the prior art. In this context, an aircraft 1 is lifted by means of two cranes 11. In order to be able to lift the aircraft 1, straps 15, which can surround the tail of the aircraft, can be arranged on booms 13 of the cranes 11. The cranes 11 provide the possibility of being able to lift a multiplicity of different aircraft types (not shown) since the straps 15 can be arranged on virtually any aircraft type.

However, the lifting of aircraft with cranes is complex since usually a plurality of cranes have to be coordinated precisely with one another. Most aircraft can be lifted completely by a coordinating use of two to four cranes.

Furthermore, lifting aircraft by means of inflatable cushions is known in the prior art (DE 27 49 507 A1). Lifting an aircraft by means of inflatable cushions is illustrated in FIG. 1c with respect to the prior art. FIG. 1c shows an aircraft 1 under which three inflatable cushions 19 are arranged. Each of the inflatable cushions 19 comprises here a plurality of chambers 20, wherein the chambers 20 are each connected to input devices 5′ via hoses 9′. The cushions 19 are arranged underneath the region 22 of an aircraft which is to be lifted. The aircraft is lifted by inflating the cushions 19 or the chambers 20 of the cushions 19. If necessary, it is additionally possible to provide for the cushions 19 to be spaced apart from the underlying surface by means of a substructure 17. The cushions 19 are always at a predetermined maximum height in the fully inflated state, with the result that in the case of relatively large aircraft if necessary substructures 17 can be arranged under the cushions 19 in order to reach the required height for lifting the aircraft. In this context, the cushions 19 are usually inflated by means of a compressor (not shown).

In order to lift an aircraft with inflatable cushions it is decisive that they can only be arranged in specific areas of the aircraft which are predefined by the manufacturer and that the pressure of the cushion in the predefined area does not exceed limiting values predefined by the manufacturer during the lifting of the aircraft. If the pressure exceeds the predefined limiting value during the lifting process, damage can occur to the aircraft. Such damage to aircraft is more difficult to determine owing to modern materials since composite materials or the like are being increasingly used in the construction of aircraft, in which composite materials an excessively strong force effect can lead exclusively to damage to the inner structure of the affected areas, which it is difficult to see, or cannot be seen, from the outside.

Further lifting apparatuses are known from DE 34 16 375 A1 and WO 2004/087459 which are embodied as lifting apparatuses, wherein the aircraft can be transported away after the lifting with these apparatuses.

The apparatuses from the prior art have here, in particular, the disadvantage that they are either very complex, such as the recovery and lifting of aircraft with cranes, or they require apparatuses which are individually adapted for each aircraft type, such as in the case of the recovery jacks. The known inflatable cushions are, in contrast, cost-effective and very variable to use. A disadvantage of the inflatable cushions, is, however, that it is no longer ensured that the pressure acts uniformly from the cushion on the predetermined area of the aircraft. Such uniform pressure, and therefore uniform transmission of force, is, however, necessary to avoid damage to the aircraft.

The invention is therefore based on the object of supplying a lifting apparatus for aircraft which overcomes the disadvantages of the prior art. In particular, an apparatus is to be made available which permits controlled transmission of force from a lifting apparatus with inflatable cushions to predetermined areas of an aircraft.

This object is achieved in that the lifting apparatus comprises a pressure-sensitive device with at least two pressure sensors, and the pressure-sensitive device is arranged between the uppermost chamber of the cushion and the area of the aircraft which is to be lifted.

It is also preferred that the lifting apparatus comprises at least two modules, wherein each of the modules has at least two chambers and the chambers can be detachably connected to one another.

According to the invention it is also preferred here that the pressure sensors of the pressure-sensitive device, in particular at least one of the pressure sensors, are/is embodied in such a way that the pressure sensor or sensors can register a maximum measured value of 1 bar, preferably at maximum 0.5 bar, in particular at maximum 0.3 bar, and wherein, in particular, the pressure sensors of the pressure-sensitive device are arranged at regular predetermined intervals, in particular at regular intervals in a range from 10 cm to 30 cm, wherein the pressure-sensitive device is preferably composed of a mat and/or of a film-like material or is introduced directly into the upper side of the uppermost chamber, in particular by means of a spraying process or molding process.

It is also possible to provide that each pressure sensor comprises a pressure-sensitive, piezo-resistive sensor element, wherein the pressure sensors are preferably composed of a thin printed circuit, and wherein the pressure sensors comprise, in particular, two substrate layers, preferably a substrate layer made of polyester and a substrate layer made of polyimide.

In particular, it is preferred that the pressure-sensitive device be composed at least in certain regions of a compressible material and comprise at least two magnets or magnetic particles, wherein the magnets or magnetic particles are moved by compression or expansion of the pressure-sensitive device, with the result that a change in the magnetic field which is generated by the magnets or magnetic particles occurs, wherein these changes is representative of a change in the pressure during the lifting of the aircraft.

In this context it is possible to provide that at least one magnetic sensor be included, for example a Hall sensor, for measuring the change in the magnetic field, wherein the magnets or magnetic particles and the magnetic sensor form, in particular, a pressure sensor, and wherein the pressure-sensitive device preferably comprises a foamed mat, wherein the plastic foam comprises the magnets or magnetic particles and the magnetic sensor.

In particular, it may prove advantageous that a data processing device stores measured values of the pressure-sensitive device, in particular of the pressure sensors of the pressure-sensitive device, a current time, a date, a temperature, a user identifier, an aircraft type and/or further information, wherein information about characteristic numbers and values of various aircraft types can preferably be made available by means of the data processing device, and in particular, the measured values of the pressure-sensitive device are reconciled with the characteristic numbers and values.

It is also possible to provide according to the invention that the uppermost chamber of the lifting apparatus comprises loose plastic balls, with the result that the uppermost chamber is adapted to the contour of the area of the aircraft which is to be lifted, wherein after the adaptation the air in the uppermost chamber is substantially removed by means of a suction pump, with the result that the plastic balls are secured by means of the resulting underpressure.

According to the invention it is also preferred that a substructure is included which spaces apart the inflatable cushion from the underlying surface.

It is also possible to provide that at least one chamber of the inflatable cushion, in particular the uppermost chamber or one of the upper chambers, is divided into at least two, preferably three, four or six, partial chambers, wherein compressed air can be applied to the partial chambers, in each case separately from one another.

In particular it is preferred that an input device for actuating the pressure control device is included, wherein at least two separate pressure control devices can preferably be actuated with the input device.

It is preferred here that the input device is embodied as a mobile input device and communicates, in particular, in a wireless fashion with the pressure control device or devices.

It is also possible to provide that a display device is included which displays at least one representative of a measured value of at least one pressure sensor of the pressure-sensitive device, wherein the arrangement of the displayed representatives of the measured values of the pressure sensors on the display device preferably corresponds to the spatial arrangement of the pressure sensors in the pressure-sensitive device.

According to the invention it is also possible to provide that an acoustic and/or visual warning signal is output by means of the display device or a further output device if a measured value of the pressure exceeds a predefined maximum permissible value, wherein the lifting of the aircraft is preferably interrupted automatically just before the permissible value is exceeded.

In particular it can prove advantageous that the representatives of the measured values of the pressure sensors of the pressure-sensitive device are displayed in color on the display device, wherein in particular the measured values are displayed in green, yellow or red as a function of predetermined measurement ranges.

It is also possible to provide according to the invention that the position of the pressure-sensitive device relative to the aircraft is displayed on the display device, in particular the position of all the pressure-sensitive devices.

According to the invention it is also possible to provide that the display device is embodied integrally with the input device, in particular in the form of a touchscreen, a tablet PC or the like.

Finally, it is also possible to provide that a control box is included, wherein the control box is arranged between the compressor and at least one of the lifting apparatuses, and the control box comprises the pressure control device, preferably in the form of control valves, in particular solenoid valves, and wherein the control box comprises an emergency operator control device, with the result that the pressure control device can be operated directly from the control box, wherein the control box preferably comprises control software.

The invention is therefore based on the surprising realization that excessively high pressure during the lifting of an aircraft can be prevented if a pressure-sensitive device is arranged between an uppermost chamber of an inflatable cushion and the area of the aircraft which is to be lifted. By means of the pressure-sensitive device, the pressure distribution in the area of the aircraft which is to be lifted can be measured directly and displayed to a user, with the result that controlled lifting of the aircraft is made possible.

The inflatable cushion can make available large forces, in particular forces of more than 300 kN, with the result that it is decisive to transmit the forces made available by the cushion uniformly to a provided area of an aircraft. The compressed air which is required by the lifting apparatus is preferably made available here by means of one or more compressors.

In order to prevent a maximum permissible pressure at the area of the aircraft which is to be lifted from being exceeded, on the one hand the correct dimensioning of the cushion which is used is decisive in terms of geometric dimensions, since the pressure which is applied by the cushion to the aircraft area during the lifting process is known to be determined by means of the quotient of the force by the area. On the other hand, it is necessary for the cushion to bear tightly against the contours of the area of the aircraft which is to be lifted. If the cushion bears against the tail of the aircraft or of the wings only in certain areas, a substantially higher pressure is applied to the aircraft in the areas against which the cushion bears than is permitted, and the force is therefore concentrated on specific partial areas of the area which is to be lifted.

In this context it can be advantageous if the pressure sensors of the pressure-sensitive device are arranged at regular intervals. In this context, the pressure sensors, in particular an individual pressure sensor, can be configured in such a way that they/it can register a maximum measured value of 1 bar, preferably at maximum 0.5 bar, and in particular at maximum 0.3 bar. It has proven advantageous if the pressure sensors are arranged at a regular interval of 10 to 30 cm and form a matrix, wherein the pressure sensors are distributed uniformly over virtually the entire surface of the upper side of the uppermost chamber of the inflatable cushion. It is therefore possible to ensure that the force from the cushion is distributed uniformly over the area of the aircraft which is to be lifted, and the pressure does not exceed the predefined limiting values at any time.

For example, a pressure-sensitive device with a length of 290 cm and a width of 220 cm can be provided which comprises in total 638 pressure sensors which are arranged at a regular and identical interval of 10 cm with respect to one another. It is also possible to provide that in the case of a pressure-sensitive device with identical dimensions, 180 pressure sensors are used, wherein they are arranged at a regular and identical interval of 20 cm from one another. Alternatively, it is also possible to provide that in the case of a further pressure-sensitive device with the dimensions above, 319 pressure sensors are used at alternating regular intervals of 10 cm and 20 cm. It is also possible to provide that a pressure-sensitive device having the dimensions above comprises 158 pressure sensors which are arranged at alternating regular intervals of 15 cm and 30 cm. A multiplicity of different forms of arrangement of the pressure sensors are possible.

It is advantageously possible for the pressure-sensitive device to be made available in the form of a mat, a film or the like, wherein the pressure sensors form an integral component. Such a mat or film can according to the invention also be combined with existing lifting apparatuses for aircraft which have not until now had a pressure-sensitive device according to the invention. Alternatively it is possible to provide that the pressure-sensitive device is introduced directly into the upper side of the uppermost cushion, for example by means of a spraying process or molding process.

The pressure sensors can advantageously comprise a pressure-sensitive, piezo-resistive sensor element, wherein the pressure sensors can be composed of a thin, printed circuit. In particular it is possible to provide that the pressure sensors comprise two substrate layers, preferably a substrate layer made of polyester and a substrate layer made of polyimide. As a result of this design of the pressure sensors it is possible for the latter to be integrated easily and cost-effectively into the pressure-sensitive device in the form of a mat or film or to be introduced directly into the upper side of the uppermost chamber of the cushion.

Alternatively it is possible to provide that magnets can be used as a pressure sensor. In this context it is possible to provide, for example, that small magnets are introduced into a compressible, pressure-sensitive device, in particular into a pressure-sensitive device in the form of a mat or the like. Changing the volume of the pressure-sensitive device causes the position of the magnets and therefore the resulting magnetic field to change. The magnetic field can be detected by means of a sensor device, for example in the form of a magnetic sensor (Hall sensor), a coil or the like, and the change in the magnetic field can be evaluated as information about a pressure present in the area which is to be lifted.

Preferred magnets are, for example, super magnets composed of NdFeB in a wafer format with a wafer thickness of 0.8-1.5, preferably approximately 1 mm and a wafer diameter of 5-15, preferably 6-10 mm. They have an adhesive force in the range from 350-500 g, i.e. they can secure an object up to such a weight given horizontal orientation of the magnetic wafer. The remanence B of the magnets is correspondingly in a range from 1.2-1.5, preferably 1.3-1.4 Tesla (T). The optimum value of the measuring range of such magnets is in a measuring distance of the magnet from the sensor in a range of 8-21 mm, wherein the field strength decreases logarithmically as the distance increases. For a super magnet of the thickness 1 mm and of the diameter of D=6; 8; 10 mm, the magnetic field strength across the magnet is approximately 1 mT given a distance of 17; 21; or 25 mm from the sensor, and approximately 10 mT given a distance of approximately 7; 9; 11 mm, and then increases steeply at even smaller distances. For this reason, the pressure ratios in the pressure mat can be determined precisely from the change in the magnetic field strength.

A Hall sensor which has a typical sensitivity of approximately 5-15, preferably approximately 10 mV/G (G=gauss, wherein 10 000 gauss correspond to 1 Tesla) and an output bandwidth of 2-20, preferably approximately 10 kHz is preferably used as magnet sensor device. The Hall sensor is usually arranged on a controller printed circuit board which is embedded in the foam mentioned below, wherein a magnet is located in each case at a predetermined distance from the Hall sensor, thereby forming the pressure sensor, in a complementary fashion on the side lying opposite the foam layer.

In this context it is also possible to provide that the pressure-sensitive device comprises a foam, wherein the magnets or magnetic particles are introduced into the foam. As a result, a compressible permanent magnet can be made available, wherein distribution and the changes in the magnetic field can be registered by means of sensor devices. The thickness and compressibility of the foam layer is selected in such a way that it is at least 20 mm thick (30 mm thick according to one preferred example), and is compressed by 6-13 mm, preferably approximately 7-9 mm, given an overpressure of 0.5 bar. As a result, a measured value between 1-10 mT and more is generated at the Hall sensor, as a result of which measurement voltages between 0.1 and 1 V and more can be measured with the above Hall sensor (sensitivity 10 mV/G).

A pressure-sensitive device can be constructed by connecting the respective controller printed circuit board to a central controller and an A/D converter and a Bluetooth transceiver, with which the measured data can be forwarded by radio.

A multiplicity of virtual pressure sensors are made available together with the magnets by the sensor devices, wherein the sensor devices can be arranged precisely like the pressure sensors prescribed above.

For uniform transmission of the forces of the lifting apparatus to the area of the aircraft which is to be lifted it can be provided according to the invention that the contour of the lifting apparatus is adapted to the area which is to be lifted. The need for such adaptation of a contour becomes clear, for example, from the fact that a lifting apparatus which is arranged under a wing of an aircraft has to compensate for the slope of the wing in order to be able to transmit the forces uniformly. This occurs, of course, to the same extent for other areas of an aircraft such as the tail or the nose. In this context it is possible to provide that the uppermost chamber of the cushion is filled with a multiplicity of loose plastic balls. Of course, it is also conceivable that instead of plastic balls any desired other materials which are suitable for such contour adaptation are used. These loose plastic balls can adapt in an optimum way to various surface contours and therefore permit uniform transmission of forces of the lifting apparatus. Alternatively it is, of course, also possible to provide that contour adaptation is carried out by means of other devices. Compressed air is not applied to the uppermost chamber but instead air is removed from the uppermost chamber by means of a suction pump and an underpressure is generated. The underpressure fixes the plastic balls in terms of their shape which is adapted to the area of the aircraft and causes the plastic balls to form a fixed structure. Of course, there is provision that after the termination of a lifting process the uppermost chamber is filled with air again, with the result that the plastic balls can be released from their fixed state.

A substructure which is arranged between the ground and the lifting apparatus can also be provided. Different aircraft types are of different heights, with the result that the distance of an area which is to be lifted from the ground varies. The lifting apparatus can always only generate maximum lift by inflating the cushion or the individual chambers of the cushion. If this lift is not sufficient to lift sufficiently the area which is to be lifted, a substructure can be used. The construction of the substructure is variable here. In this context, the substructure can also be composed of a further inflatable cushion, wherein, of course, a multiplicity of further spacing devices for making available a substructure, such as, for example, a substructure made of wood or the like, are also familiar to a person skilled in the art.

In addition to the lifting apparatus bearing tightly against the area of the aircraft which is to be lifted it is decisive that the change in the relative position of the lifting apparatus with respect to the area which is to be lifted can be taken into account during the lifting. This change in the relative position results from a rotation of the aircraft during the lifting process. Owing to this change in the relative position of the aircraft with respect to the cushion, an excessively large force can act on a partial area of the area of the aircraft which is to be lifted and can damage it. This results from the fact that the area which bears against the aircraft is reduced by the change in the relative position, and correspondingly the pressure in the areas in which the cushion continues to bear increases as a result of the constant force.

In order to compensate for the relative displacement of the area which is to be lifted with respect to the lifting apparatus it is possible to provide that at least one chamber of the inflatable cushion, in particular one of the upper chambers or the uppermost chamber, is divided into at least two partial areas which are separated from one another, that is to say partial chambers. In this context it is possible to provide that three or six partial chambers are formed, to each of which compressed air can be applied separately. This leads to a situation in which the changing relative position of the lifting apparatus with respect to the area which is to be lifted can be compensated during the lifting process in that the lift of the inflatable cushion is varied by the a different lift of the partial chambers relative to the area of the aircraft which is to be lifted.

In particular the pressure-sensitive device according to the invention is advantageous for such compensation. The forces and pressures which are applied to the area of the aircraft which is to be lifted can be displayed to a user who regulates lifting of the aircraft by means of an input device, with the result that said user can actuate the partial chambers selectively. Through such actuation of the partial chambers, the lift can be varied and application of the lifting apparatus is ensured during the entire lifting process. This is relevant, in particular in practice since, on the one hand, the user has to maintain a safety distance from the aircraft owing to a risk of injury and, on the other hand, precise consideration of the displacement of the relative position of the lifting apparatus and area which is to be lifted is difficult owing to the geometric dimensions of the lifting apparatus and of the aircraft.

According to the invention it is also possible to provide that a data processing device is operatively connected to the lifting apparatus. Owing to technical insurance requirements, the lifting of an aircraft has to be precisely documented, in particular also the forces and pressures applied to the area which is to be lifted. A data processing device according to the invention can store, for example alongside further data, the measured values of the pressure-sensitive device, in particular of the individual pressure sensors of the pressure-sensitive device, a current time of day, a date, a temperature, an aircraft type and/or a user identifier. In this context it is also possible to provide that characteristic numbers and values of various aircraft types are stored in the data processing device and the measured values are reconciled directly with the characteristic numbers and values.

According to the invention, an input device for actuating the pressure control device can also be included, wherein the input device can also be suitable for actuating two or more pressure control devices. This may be advantageous, in particular, when a plurality of lifting devices are used simultaneously, with the result that the user does not have to change between different input devices but instead can perform all the relevant inputs in a short time by means of an input device. In this context it may be advantageous, in particular, if the input device is embodied as a mobile input device and communicates in a preferably wireless fashion, for example via WLAN, Bluetooth or the like, with the pressure control device or devices, and if appropriate, with further devices of the lifting apparatus.

It may also be advantageous if the lifting apparatus comprises a display device which displays at least one representative of a measured value of at least one pressure sensor of the pressure-sensitive device. In this context it can be provided that the order of the displayed measured values of the pressure sensors on the display device corresponds to the spatial arrangement of the pressure sensors in the pressure-sensitive device. For example, each of the pressure sensors which are arranged in a regular matrix is displayed as a separate measured value, or a representative of the measured value, in a matrix which is displayed on the display device, with the result that an indication of the pressure in various parts of the area which is to be lifted is displayed to the user. As a result, for example through selective actuation of partial chambers of the inflatable cushion, the user can correct, even without visual contact, the relative position of the lifting apparatus with respect to the area of the aircraft to be lifted, during the lifting process. In practice, this provides a considerable saving in time and also advantages in terms of safety.

It is also possible to provide that an acoustic and/or visual warning signal is output by means of the display device or a further output device if a measured value of the pressure exceeds a predefined, maximum permissible value. In this context, for example the measured pressure values are compared with the maximum values which are stored in the data processing device and are specific for a respective aircraft type, and an effective auxiliary means is therefore made available to the user, in order to avoid damage to the areas which are to be lifted. Furthermore, it is also possible to provide that the lifting of the aircraft is interrupted automatically just before the permissible value is exceeded. The maximum permissible value of the pressure is between 0.1 and 1 bar, preferably between 0.2 and 0.5 bar, and is, in particular, 0.3 bar.

In particular it may be advantageous if the measured values of the pressure sensors of the pressure-sensitive device are displayed in color on the display device. In this context, the measured values can be displayed in green, yellow or red, or of course, in any other colors, depending on predetermined measuring ranges. For example, measured values which lie in a measuring range which is defined as safe can be displayed in the color green, while measured values which exceed a predefined limiting value are displayed in the color red. Furthermore, any desired intermediate ranges can be defined, these being displayed, for example, in yellow or orange and being representative of the predefined limiting values being approached.

It is also possible to provide that the position of the pressure-sensitive device relative to the aircraft is displayed on the display device. This permits a user to detect quickly in which partial area of the area which is to be lifted it appears appropriate to engage, under certain circumstances. This may be advantageous, in particular, when more than one lifting apparatus is used, with the result that the user quickly detects what pressure is applied by which lifting apparatus at the area or areas to be lifted. It can therefore be particularly advantageous to display the position of all the pressure-sensitive devices simultaneously, or if appropriate, sequentially on the display device in a relative position with respect to the aircraft and the areas which are to be lifted.

The display device can also be embodied in an integrated fashion with the input device, in particular in the form of a touchscreen. It can be advantageous here if a touchpad, tablet PC or the like is used, with the result that a mobile input and output device is made available to the user. By means of such a mobile input and output device, which communicates, in particular, in a wireless fashion with the further devices of the lifting apparatus, the user can without difficulty accompany the lifting of the aircraft from various positions and have the relevant areas which are to be lifted continuously in view.

It is also possible to provide according to the invention that one or more pressure control devices are integrated into a control box according to the invention. A control box according to the invention can comprise for this purpose, for example, control valves, in particular solenoid valves. In this context, the control box can be arranged according to the invention between a compressor and one or more lifting apparatuses, with the result that the compressed air can be fed in a regulated fashion to the individual chambers of the inflatable cushion of the lifting apparatus from the compressor via the control box. Likewise, a reduction in the pressure can be brought about by means of the control box. An actuation of the control box is preferably performed here by means of an input device which is arranged separately from the control box and which, as already described above, can communicate with the control box by means of WLAN or the like.

Furthermore, a control box according to the invention can comprise the emergency operator control devices, with the result that the lifting apparatuses can be controlled directly at the control box even in an emergency.

A control box according to the invention has a multiplicity of advantages, wherein reference is made to the following by way of example. Instead of making available a multiplicity of separate pressure control devices, as is customary in the prior art, and connecting these separately in each case to the compressor and in each case to an inflatable cushion, the control box according to the invention can be arranged entirely in the vicinity of one or more cushions because the user controls the lifting process with the input device which is separate from the control box. As a result, a considerable quantity of hose material can be saved because the necessary safety is made available by means of the separate input device and, under certain circumstances, only one control box with a multiplicity of integrated pressure control devices is then used for a plurality of lifting apparatuses.

It is also possible to provide that the regulation of the lifting is assisted, and at least partially automated, by means of software, for example SPS, which is integrated in the control box. In this context it is possible to provide that a comparator is used which compares setpoint values of the pressure with actual values and on the basis of this comparison regulates the pressure in the chambers of the lifting apparatus. For example, the lifting can be interrupted automatically just before a permissible maximum pressure is reached in an area of the area of an aircraft which is to be lifted.

Further features and advantages of the invention can be found in the following description in which exemplary embodiments of the invention are explained by way of example with reference to schematic drawings, without limiting the invention thereto.

In said drawings:

FIG. 1a shows a schematic side view of lifting of an aircraft with recovery jacks according to the prior art;

FIG. 1b shows a perspective view of lifting of an aircraft with cranes according to the prior art;

FIG. 1c shows a schematic front view of lifting of an aircraft by means of inflatable cushions according to the prior art;

FIG. 2 shows a schematic front view of the start of lifting of an aircraft by means of a lifting apparatus according to the invention;

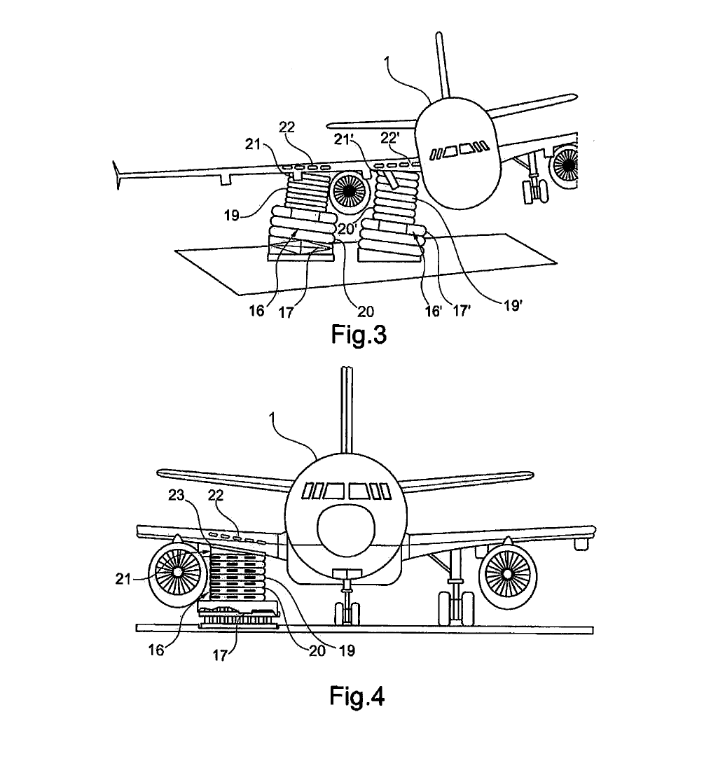

FIG. 3 shows a schematic front view of lifting of the aircraft from FIG. 2 during the lifting by means of a lifting apparatus according to the invention;

FIG. 4 shows a schematic partial view of lifting of an aircraft by means of a lifting apparatus according to the invention, from the front;

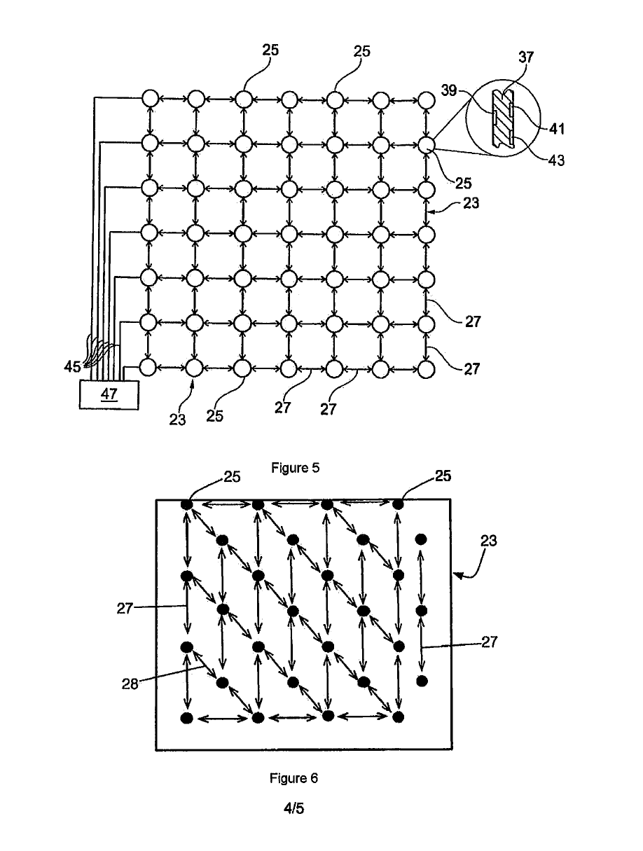

FIG. 5 shows a schematic plan view of a pressure-sensitive device according to the invention, wherein a detail of the pressure sensor on a pressure mat is illustrated in cross section;

FIG. 6 shows a schematic plan view of a further pressure-sensitive device according to the invention;

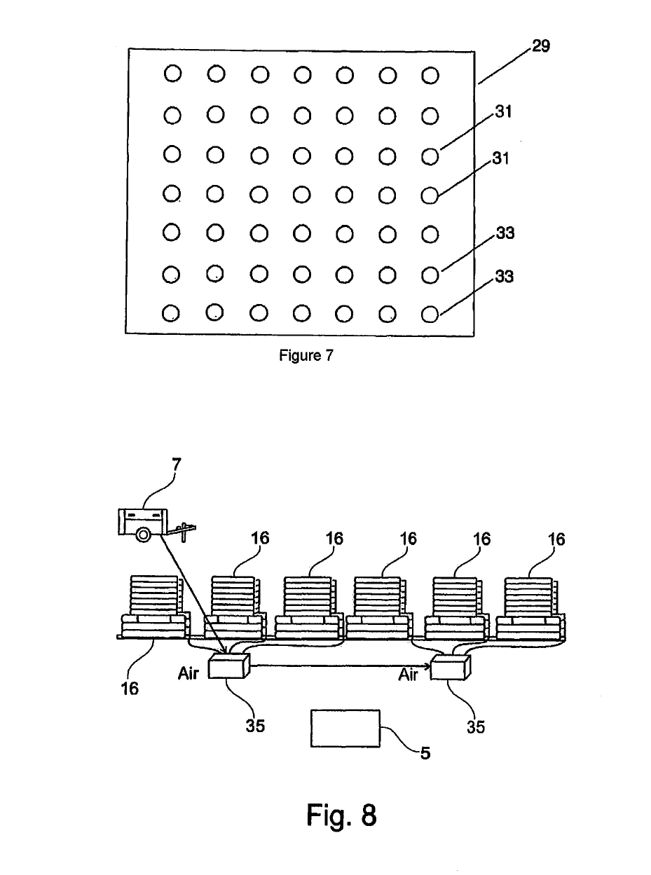

FIG. 7 shows a schematic partial view of a display device according to the invention; and

FIG. 8 shows a schematic view of a lifting apparatus according to the invention with a control box according to the invention.

In the text which follows, lifting of an area 22 of an aircraft 1 by means of a lifting apparatus 16 according to the invention for aircraft is described with reference to FIG. 2. A lifting apparatus 16 according to the invention comprises here a first inflatable cushion 19 which is arranged underneath a first area 22 which is to be lifted, in the example shown underneath a wing of the aircraft 1. The first cushion 19 comprises at least two chambers 20, 21, wherein the uppermost chamber 21 can be adapted, in particular, to the contour of the area 22 which is to be lifted. In order to be able to ensure desired lifting of the aircraft to a predetermined height, the first cushion 19 is arranged on a first substructure 17, wherein the first substructure 17 can be made available, for example, by means of a wooden substructure (now shown) or in the form of a further inflatable cushion.

Lifting of the aircraft 1 can be regulated manually here by means of input devices 5′ by opening and closing compressed air valves, wherein in this exemplary embodiment, which is to be understood only in an exemplary fashion, the input devices 5′ are operatively connected directly to hoses 9′, with the result that compressed air, which is made available by a compressor (not shown) can be applied in a selective fashion to the cushion 19. According to the invention it is also provided, in particular, that a mobile input device (not shown) is used to regulate the lifting of the aircraft 1.

According to the invention, a pressure-sensitive device (not shown) is arranged between the uppermost chamber 21 of the first cushion 19 and the first area 22 which is to be lifted.

In addition to the first lifting apparatus 16 with the first inflatable cushion 19, two further lifting apparatuses 16′, 16″ with inflatable cushions 19′, 19″ are arranged underneath the aircraft 1. In this context, the second cushion 19′ is also arranged under the wing of the aircraft 1, and the third cushion 19″ is arranged under the nose of the aircraft 1. The construction which is illustrated therefore shows the case of lifting of the aircraft 1 in which both one of the main sets of landing gear and the front set of landing gear is damaged.

It is obvious here that the position of the areas 22, 22′, 22′ which are to be lifted is determined as a function of an aircraft type and the type of lifting.

For uniform transmission of the forces of the cushions 19, 19′, 19″ to the areas 22, 22′, 22″ of the aircraft 1 which are to be lifted it is possible to adapt the contours of the uppermost chambers 21, 21′, 21″ of the cushion 19, 19′, 19″ to the areas 22, 22′, 22″ which are to be lifted. The need for such contour adaptation becomes clear, in particular when the third cushion 19″, which is intended to lift a third area 22″ at the tail of the aircraft 1, is considered. Without contour adaptation of the third cushion 19″ or of the uppermost chamber 21″ of the cushion 19″, uniform transmission of force to the third area 22″ would not be possible. It is possible to provide here that the uppermost chamber 21″ of the third cushion 19″ is filled with a multiplicity of loose plastic balls. Of course, it is also conceivable that instead of plastic balls any other materials which are suitable for such contour adaptation can be used. Compressed air is not applied to the uppermost chamber 21″ for the purpose of contour adaptation but instead air is removed from the uppermost chamber 21″, and an underpressure is generated, by means of an extraction pump (not shown). The underpressure fixes the plastic balls in terms of their shape which is adapted to the area 22′ of the aircraft 1 which is to be lifted, and they form a fixed structure. It is apparent that such contour adaptation can be provided equally for the first and second cushions 19, 19′.

FIG. 3 shows the aircraft 1 with the lifting apparatuses 16, 16′ according to the invention from FIG. 2 during lifting of the aircraft 1. During the lifting of the aircraft 1 it is decisive to take into account the change in the relative position of the cushions 19, 19′ with respect to the areas 22, 22′ to be lifted. Owing to this change in the relative position of the aircraft 1 with respect to the cushions 19, 19′, an excessively large force can act on partial areas of the areas 22, 22′ of the aircraft which are to be lifted and damage the latter. Basically, the displacement of the relative position results here from a rotational movement of the aircraft 1 during the lifting. As illustrated in FIG. 3, the cushions 19, 19′ are displaced from a perpendicular position into a slightly inclined position. If the inclination becomes too large, it can lead to slipping of the cushions 19, 19′, and even make further lifting of the aircraft 1 impossible, wherein, in particular, completely different pressure conditions can be set over the entire cushion width. Such different pressure conditions can be controlled with the pressure-sensitive device described below.

Possible compensation of the relative displacement of an inflatable cushion 19 of the lifting apparatus 16 according to the invention from FIGS. 2 and 3 is shown in FIG. 4. An uppermost chamber 21 or one of the upper chambers 20 of the cushion 19 are divided here into at least two partial areas which are separate from one another, that is to say partial chambers (not shown). Pressure can be applied separately to each of the partial chambers (not shown). Selective actuation of these partial chambers permits the relative displacement of the cushion 19 with respect to the area 22 to be compensated by adapting the inclination of the chamber 21 which is divided into at least two partial chambers, or one of the upper chambers 20 of the cushion 19. On the one hand, the actuation of the partial chambers of the cushion 19 can be used to lift the aircraft 1 safely, and on the other hand, maximum predefined pressure values in the area 22 which is to be lifted can be complied with. The pressure is measured here, as already described in the exemplary embodiments according to FIGS. 2 and 3, by means of a pressure-sensitive device 23 which is arranged between the uppermost chamber 21 and the area 22 of the aircraft 1 which is to be lifted.

FIG. 5 shows a schematic plan view of a pressure-sensitive device 23 according to the invention. The pressure-sensitive device 23 comprises here a multiplicity of pressure sensors 25 which are generally arranged at a predetermined distance 27. In this context it is possible to provide, in particular, that the distance 27 is 10 cm.

FIG. 5 also shows a detail of a pressure sensor 25 in cross section which is arranged on a pressure mat 37 composed of a flexible, compressible plastic material, preferably silicone rubber. The pressure sensor 25 is composed of a magnet 39 and a Hall sensor 41, which are each embedded opposite one another in the surfaces of the pressure mat 37. The Hall sensor 41 is in turn connected to a transmitting device 43 (for example Bluetooth circuit board with Bluetooth chip), which is also embedded in the pressure mat 37. The individual pressure sensors 25 are connected via lines 45 to a controller 47, which receives the analog signal and converts it, by means of an A/D converter, into digital signals which are passed onto the transmitting device 43.

FIG. 6 shows a further schematic plan view of a pressure-sensitive device 23 according to the invention. The pressure-sensitive device 23 also comprises here a multiplicity of pressure sensors 25 which are generally arranged at a first predetermined distance 27 and at a second predetermined distance 28 with respect to one another. In this context, the first predetermined distance 27 can be 30 cm and the second predetermined distance can be 15 cm, with the result that 28 pressure sensors 25 are used per square meter of the pressure-sensitive device 23. Of course, various other arrangements of pressure sensors 25 are also conceivable.

It can be advantageous here if the lifting apparatus 16, 16′, 16″ according to the invention in FIGS. 2 to 4 comprises a display device 29 corresponding to the illustration in FIG. 7, which display 29 displays at least the representatives 31, 33 of measured values of the pressure sensors 25. In this context it is possible to provide that the arrangement of the pressure sensors 25 which is illustrated in FIG. 5 corresponds to the illustration of the displayed representatives 31, 33 of the measured values on the display device 29. Such an illustration of the individual representatives 31, 33 can, for example, assist the user here in deciding which of the partial chambers of the uppermost chamber 21 or one of the upper chambers 20 has to be actuated with what lift in order to ensure reliable and defined lifting of the aircraft 1. In this context, the representatives 31, 33 of the measured values of the pressure sensors can be illustrated in color as a function of predetermined measuring ranges, and when limiting values are exceeded a warning can be issued. For example, the representatives 33 signal a high pressure in a specific partial area in one of the areas 22, 22′, 22″ which are to be lifted, in FIGS. 2 to 4. As a result, a user can readily recognize what actuation he has to perform for safe lifting.

It is also possible to provide that the position of the pressure-sensitive device 23 relative to the aircraft is displayed on the display device 29 (not shown), with the result that the user can quickly recognize the partial area of the areas to be lifted, for example the areas 22, 22′, 22″ in FIGS. 2 to 4, in which, under certain circumstances, engagement appears appropriate.

FIG. 8 shows a control box 35 according to the invention, which control box 35 is operatively connected to an input device 5, a compressor 7 and a lifting apparatus 16. The control box 35 comprises here a pressure control device (not shown) for actuating the individual chambers of the lifting apparatuses 16. The control box 35 is for this purpose connected to the compressor 7 and to the lifting apparatuses 16 by means of hoses (not shown). The control box 35 can be actuated by means of the input device 5, which communicates to the control box 35, for example by means of WLAN or similar transmitting and receiving device. It is possible to provide here that the control box 35 comprises control valves, in particular solenoid valves, and makes available both a positive pressure for filling the chambers and a negative pressure for emptying them. Furthermore, it is possible to provide according to the invention that the control box 35 comprises emergency operator control devices (not shown) in order also to be able to control the control valves directly at the control box. The actuation of the lifting apparatuses 16 which is performed by the control box 35 is controlled by means of software. In this context, an SPS controller can be provided for operating the control box 35.

The use of a control box 35 according to the invention entails a large number of advantages. A simpler design of the necessary components for lifting an aircraft can be made possible because less hose material can be used than in the prior art. The control box 35 can be arranged in the vicinity of the lifting apparatuses 16 and nevertheless the necessary safety distance can be maintained owing to the use of the input device 5 which is preferably arranged separately from the control box 35. In addition, a plurality of lifting apparatuses 16 can be actuated by means of a control box 35, with the result that as it were the required quantity of hose material can be reduced since the control box 35 can also be positioned in the vicinity of two or more lifting apparatuses 16. This can save time and personnel both in terms of construction and operation. Coordinated operation of a plurality of lifting apparatuses 16 simultaneously by means of one control box 35 according to the invention, in particular by means of the software which is made available in the control box 35 for controlling the lifting of an aircraft is also possible.

The features of the invention which are disclosed in the description above, the claims and the drawings can be essential to the implementation of the invention in its various embodiments, either individually or else in any desired combination.

### LIST OF REFERENCE NUMBERS

1 Aircraft
3 Recovery jack
4 Hydraulic assembly
5 Input device
6 Generator
7 Compressor
9,9′ Hose
11 Crane
13 Boom
15 Strap
16 Lifting apparatus
17, 17′, 17″ Substructure
19, 19′, 19″ Cushion
20, 20′, 20″, 21, 21′, 21″ Chamber
22, 22′, 22″ Area
23 Pressure-sensitive device
25 Pressure sensor
27, 28 Distance
29 Display device
31, 33 Representative
35 Control box
37 Pressure mat
39 Magnet
41 Hall sensor
43 Transmitting device
45 Line
47 Controller

1. A lifting apparatus (16, 16′, 16″) for an aircraft (1), comprising at least one inflatable cushion (19, 19′, 19″) with at least two chambers (20, 20′, 20″, 21, 21′, 21″), at least one compressor (7) and at least one pressure control device, wherein each of the chambers (20, 20′, 20″, 21, 21′, 21″) is connected to the compressor (7) via the pressure control device by means of a hose (9, 9′), characterized in that the lifting apparatus (16, 16′, 16″) comprises a pressure-sensitive device (23) with at least two pressure sensors (25), and the pressure-sensitive device (23) is arranged between the uppermost chamber (20, 20′, 20″, 21, 21′, 21″) of the cushion (19, 19′, 19″) and the area (22, 22′, 22″) of the aircraft (1) which is to be lifted.

2. The lifting apparatus as claimed in claim 1, characterized in that the pressure sensors (25) of the pressure-sensitive device (23) are arranged at regular predetermined intervals (27, 28), in particular at regular intervals (27, 2B) in a range from 5 cm to 50 cm.

3. The lifting apparatus as claimed in claim 1, characterized in that the pressure-sensitive device (23) is composed of a mat and/or a film-like material or is introduced directly into the upper side of the uppermost chamber (21, 21′, 21″), in particular by means of a spraying process or molding process.

4. The lifting apparatus as claimed in claim 1, characterized in that at least one of the pressure sensors (25) comprises a pressure-sensitive, piezo-resistive sensor element, wherein the pressure sensor (25) is composed of a thin printed circuit, and wherein the pressure sensor (25) comprises, in particular, two substrate layers, a substrate layer made of polyester and a substrate layer made of polyimide.

5. The lifting apparatus as claimed in claim 1, characterized in that the pressure-sensitive device (23) is composed at least in certain regions of a compressible material and comprises at least two magnets or magnetic particles, wherein the magnets or magnetic particles are moved by compression or expansion of the pressure-sensitive device (23), with the result that a change in the magnetic field which is generated by the magnets or magnetic particles occurs, wherein these changes is representative of a change in the pressure during the lifting of the aircraft (1).

6. The lifting apparatus as claimed in claim 5, characterized in that at least one magnetic sensor is included for measuring the change in the magnetic field, wherein the magnets or magnetic particles and the magnetic sensor form, in particular, a pressure sensor (25), and wherein the pressure-sensitive device (23) comprises a foamed mat or the like, wherein the foam comprises the magnets or magnetic particles.

7. The lifting apparatus as claimed in claim 1, characterized in that a data processing device stores measured values of the pressure-sensitive device (23), in particular of the pressure sensors (25) of the pressure-sensitive device (23), a current time, a date, a temperature, a user identifier, an aircraft type and/or further information, wherein information about characteristic numbers and values of various aircraft types can preferably be made available by means of the data processing device, and in particular, the measured values of the pressure-sensitive device (23) are reconciled with the characteristic numbers and values.

8. The lifting apparatus as claimed in claim 1, characterized in that an input device (5) for actuating the pressure control device is included, wherein at least two separate pressure control devices can preferably be actuated with the input device (5) and is embodied as a mobile input device (5) which communicates in a wireless fashion with the pressure control device or devices.

9. The lifting apparatus as claimed in claim 1, characterized in that a display device (29) is included which displays at least one representative (31, 33) of a measured value of at least one pressure sensor (25) of the pressure-sensitive device (23), wherein the arrangement of the displayed representatives (31, 33) of the measured values of the pressure sensors (25) on the display device (29) corresponds to the spatial arrangement of the pressure sensors (25) in the pressure-sensitive device (23).

10. The lifting apparatus as claimed in claim 9, characterized in that an acoustic and/or visual warning signal is output by means of the display device (29) or a further output device if a measured value of the pressure exceeds a predefined maximum permissible value, wherein the lifting of the aircraft (1) is preferably interrupted automatically just before the permissible value is exceeded.

11. The lifting apparatus as claimed in claim 9, characterized in that the representatives (31, 33) of the measured values of the pressure sensors (25) of the pressure-sensitive device (23) are displayed in color on the display device (29), wherein in particular the representatives (31, 33) of the measured values are displayed in green, yellow or red as a function of predetermined measurement ranges.

12. The lifting apparatus as claimed in claim 9, characterized in that the position of the pressure-sensitive device (23) relative to the aircraft (1) is displayed on the display device (29), in particular the position of all the pressure-sensitive devices (23).

13. The lifting apparatus as claimed in claim 9, characterized in that the display device (29) is embodied integrally with the input device (5), in particular in the form of a touchscreen, a tablet PC or the like.

14. The lifting apparatus as claimed in claim 9, characterized by a control box (35) with control software which is arranged between the compressor (7) and at least one of the lifting apparatuses (16), and activates the pressure control device, preferably in the form of control valves, in particular solenoid valves, wherein the control box (35) has an emergency operator control device.

15. The lifting apparatus as claimed in claim 2, characterized in that the pressure-sensitive device (23) is composed of a mat and/or a film-like material or is introduced directly into the upper side of the uppermost chamber (21, 21′, 21″), in particular by means of a spraying process or molding process.

16. The lifting apparatus as claimed in claim 10, characterized in that the representatives (31, 33) of the measured values of the pressure sensors (25) of the pressure-sensitive device (23) are displayed in color on the display device (29), wherein in particular the representatives (31, 33) of the measured values are displayed in green, yellow or red as a function of predetermined measurement ranges.
